(19) United States
(12) Patent Application Publication
(10) Pub. No.: US 2008/0005357 A1
(43) Pub. Date: Jan. 3, 2008

(54) Synchronizing dataflow computations, particularly in multi-processor setting

(75) Inventors: Dahlia Malkhi, Palo Alto, CA (US); Leslie B. Lamport, Palo Alto, CA (US); Neill M. Clift, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/479,455

(22) Filed: Jun. 30, 2006

(51) Int. Cl. G06F 15/16

(52) U.S. Cl. 709/248

(57) ABSTRACT

A process marked graph describing a dataflow is received. The graph may comprise one or more processes connected by various edges of the graph. The edges between the processes may include tokens that represent data dependency or other interrelationships between the processes. Each process may be associated with a piece of executable code. Each process in the process marked graph may be translated into a piece of executable code according to the dependencies described by the graph. The generated code for each process includes the received executable code associated with the particular process. These processes may then be executed simultaneously on one or more processors or threads, while maintaining the dataflow described by the process marked graph. In this way, synchronized dataflow is desirably achieved between processes given a process marked graph describing the dataflow, and the code associated with each process.

### BACKGROUND

We are fast approaching if not already having arrived at the day when all computers will have multiple processors, each communicating with the others by shared memory. For many computation tasks, and especially iterative tasks, a good way to make use of such multiple processors is by programming the task as a dataflow computation.

In dataflow computation, and generally speaking, an overall computational system and especially an iterative system, is broken down into multiple processes, where each process is assigned to a particular processor or the like. Thus, each processor in performing a particular process of the system reads a number of inputs with which the process is performed, typically from a shared memory, and likewise writes a number of outputs as generated by the process, again typically to the shared memory. Thus, a particular piece of data in the shared memory as an output from a first process of the system may be employed as an input to a second process of the system.

Notably, dataflow computation requires that each process of the system be synchronized with regard to at least some of the other processes. For example, if the aforementioned second process requires reading and employing the aforementioned particular piece of data, such second process can not operate until the aforementioned first process writes such particular piece of data. Put more simply, dataflow computation at any particular process of a system requires that the process wait until each input thereof is available to be read.

As may be appreciated, however, each process must somehow in fact determine when each data input thereof is in fact available to be read. A seemingly simple solution may be for each process upon writing a piece of data to notify one or more ‘next’ processes that such data is ready and can be read as an input. However, such a solution is not in fact simple, both because arranging each such notify can be quite complex, especially over a relatively large system, and because each such notify can in fact require significant processing capacity and in general is not especially efficient. Moreover, in the instance where a particular process is iteratively reading inputs from multiple sources, such a notification system does not ensure that the particular process reads a particular nth iteration of a piece of data from a first source along with a particular nth iteration of a piece of data from a second source in a matched manner, for example.

### SUMMARY

A process marked graph describing a dataflow is received. The graph may comprise one or more processes connected by various edges of the graph. The edges between the processes may include tokens that represent data dependency or other interrelationships between the processes. Each process may be associated with a piece of executable code. Each process in the process marked graph may be translated into a piece of executable code according to the dependencies described by the graph. The generated code for each process includes the received executable code associated with the particular process. These processes may then be executed simultaneously on one or more processors or threads, while maintaining the dataflow described by the process marked graph. In this way, synchronized dataflow is desirably achieved between processes given a process marked graph describing the dataflow, and the code associated with each process.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a general purpose computer system in which aspects of the disclosure and/or portions thereof may be incorporated;

FIG. 2 is an illustration of an exemplary marked graph;

FIG. 3 is an illustration of an exemplary marked graph;

FIG. 4 is an illustration of the various stages of an exemplary execution of a marked graph;

FIG. 5 is an illustration of a process marked graph representing a producer consumer system;

FIG. 6 is an illustration of a process marked graph representing a barrier synchronization system;

FIG. 7 is an illustration of a process marked graph representing a barrier synchronization system;

FIG. 8 is a block diagram illustrating an exemplary method for implementing a synchronized dataflow from a process marked graph;

FIG. 9 is a block diagram illustrating and exemplary method for the barrier synchronization of multiple processes; and

FIG. 10 is block diagram illustrating another exemplary method for the barrier synchronization of multiple processes.

### DETAILED DESCRIPTION

### Computer Environment

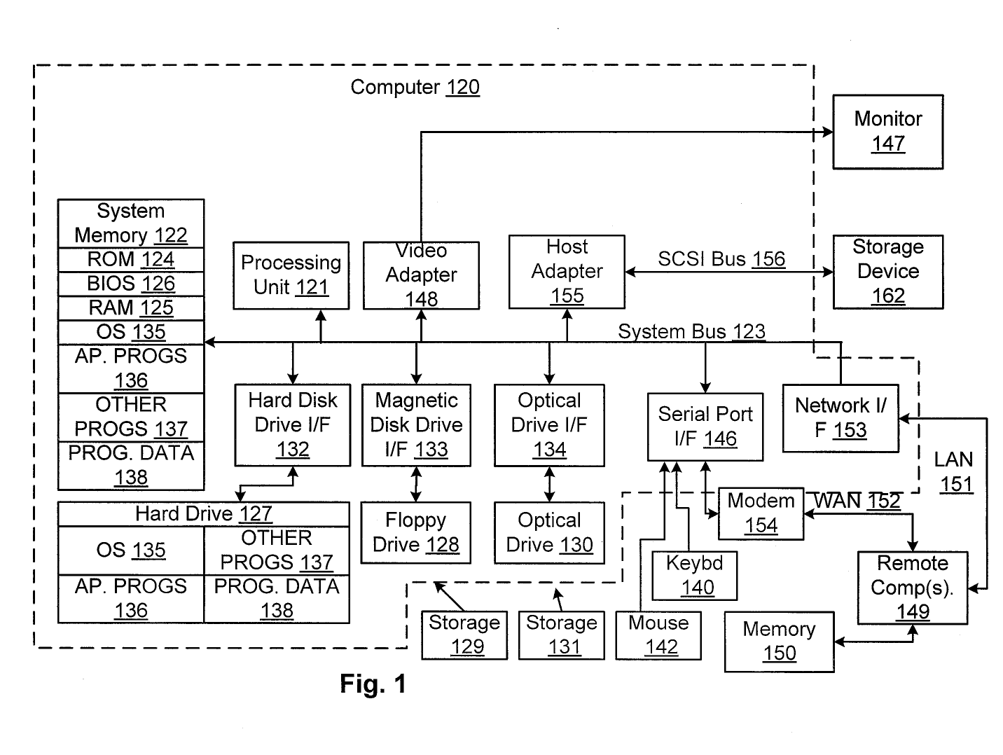

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128 and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet. The personal computer 120 may also act as a host to a guest such as another personal computer 120, a more specialized device such as a portable player or portable data assistant, or the like, whereby the host downloads data to and/or uploads data from the guest, among other things.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

Notably, it is to be appreciated that the computer environment of FIG. 1 may be operated in accordance with the present invention by having the processing unit 121 or processor instantiate multiple threads, each thread corresponding to a process of a synchronized dataflow computation. Alternatively, the computer environment of FIG. 1 may include multiple ones of such processor 121, where each such processor 121 instantiates one or more of the particular processes.

### Synchronizing Dataflow Computations

A dataflow computation is a special type of computation where computing elements send one another data values in messages. These computing elements may be computing in parallel, but generally depend on the values received from one another in order to continue. These computing elements may be implemented as separate processes executing on a single processor, or as separate processes executing on multiple processors, for example.

The computing elements desirably receive input values from other computing elements and use the values to compute output values that may be sent to other computing elements. In particular, when a dataflow computation is implemented with a shared-memory multi-processor, data values may be stored in buffers. The computing elements executing on the various processors may then inform one another when a particular buffer is available for use. In this way, the computing elements may pass values to one another using the buffers.

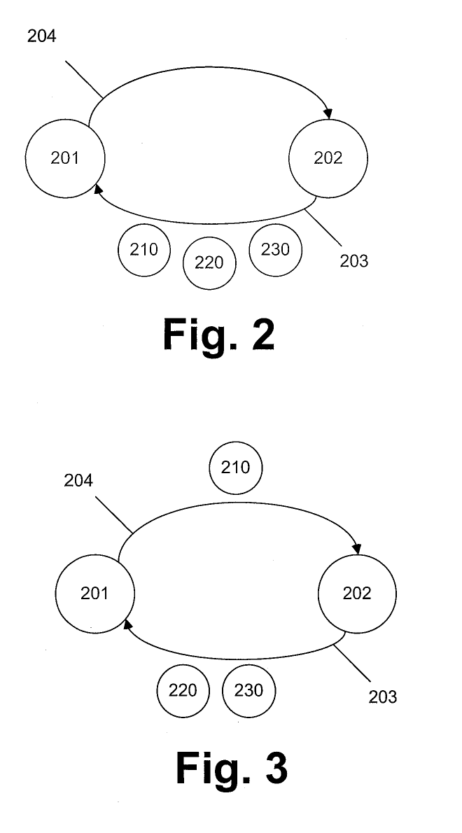

A marked graph can be useful tool to describe dataflow computations. A marked graph consists of a nonempty directed graph and a placement of tokens on its edges, called a marking. A simple marked graph is illustrated in FIG. 2. The graph comprises two nodes, labled 201 and 202. The graph further comprises edges 203 and 204, as well as tokens 210, 220, and 230. A node in a particular marked graph is said to be fire-able iff there is at least one token on each of its in-edges. Accordingly, node 201 is the only fire-able node in FIG. 2 because it has at a token on edge 203.

Firing a fire-able node in a marked graph desirably changes the marking by removing one token from each in-edge of the node and adding one token to each of its out-edges. Thus, firing node 201 will result in the graph shown in FIG. 3.

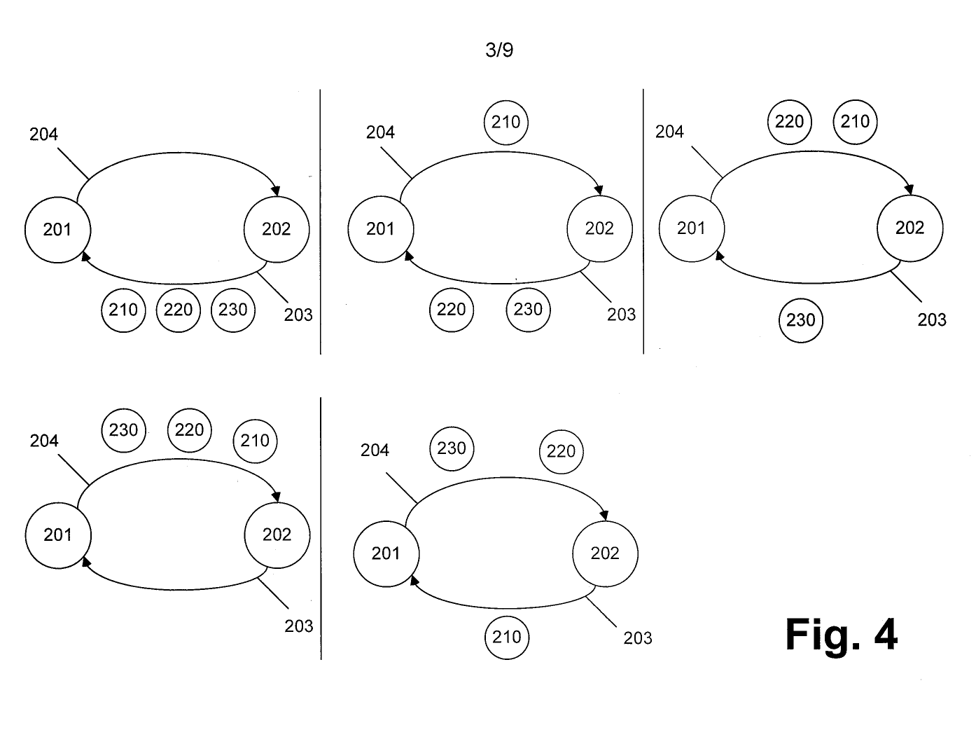

An execution of a marked graph consists of a sequence of marked graphs obtained by repeatedly firing arbitrarily chosen fire-able nodes. For example, one possible 5-step execution of the marked graph of FIG. 2 is illustrated in FIG. 4.

The marked graph of FIG. 2 is a representation of producer/consumer or bounded buffer synchronization with three buffers. The node 201 represents the producer, node 202 represents the consumer, and the three tokens 210, 220, and 230 represent the three buffers. A buffer may be considered empty if its token is on edge 203. A buffer may be considered full if its token is on edge 204. Firing node 201 represents the producer filling an empty buffer, and firing node 202 represents the consumer emptying a full buffer.

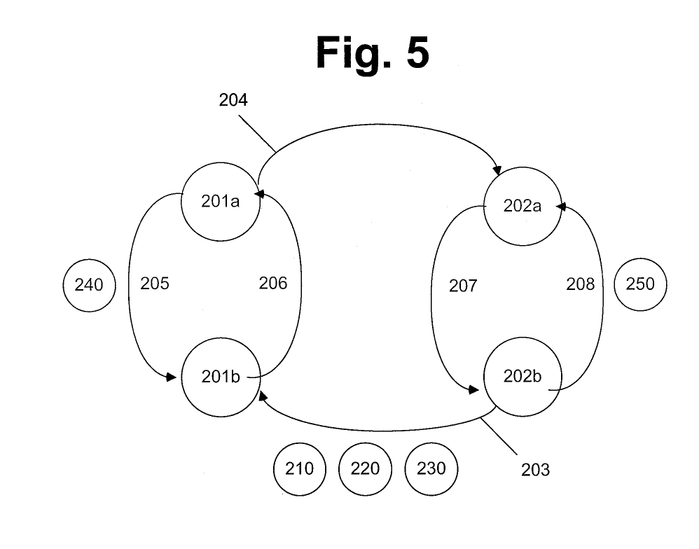

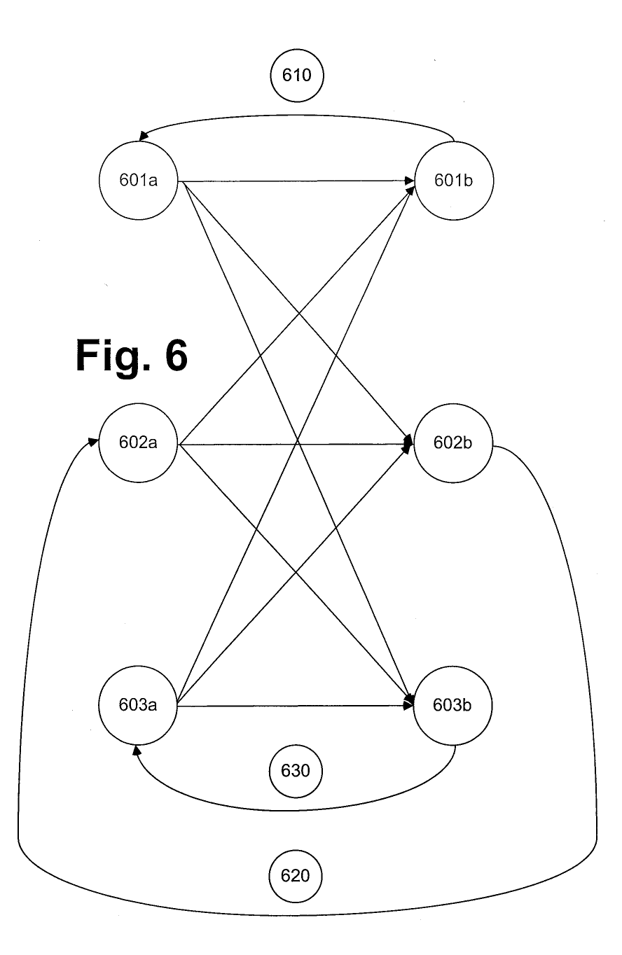

The graph of FIG. 2 can be further modified to show that the act of filling or emptying a buffer has a finite duration. Accordingly, the graph of FIG. 2 may be expanded by adding a token to each of the nodes to represent the producer and consumer processes themselves. Such a graph is illustrated in FIG. 5, for example.

The graph of FIG. 5 illustrates the replacement of the producer and consumer nodes with sub nodes. As shown, producer node 201 has been replaced with sub nodes 201a and 201b. Similarly, consumer node 202 has been replaced with sub nodes 202a and 202b. Tokens have also been added to the graph to represent the producer and consumer processes. Token 240 represents the producer process, and token 250 represents the consumer process, for example.

More specifically, a token on edge 206 represents the producer performing the operation of filling a buffer. A token on edge 205 represents the producer waiting to fill the next buffer. Similarly, a token on edge 207 represents the consumer emptying a buffer, and a token on edge 208 represents it waiting to empty the next buffer. Edges 206 and 207 may be referred to as computation edges; tokens on those edges represent a process performing a computation on a buffer.

The tokens illustrated in FIG. 5 may also represent the buffers. A token on edge 203 represents an empty, or available buffer. A token on edge 206 represents a buffer being filled. A token on edge 204 represents a full buffer. A token on edge 207 represents one being emptied. A token on edge 206 represents both the producer process and the buffer it is filling. A token on edge 207 represents both the consumer and the buffer it is emptying.

One way of representing multi-processor dataflow computations is with a type of marked graph called a process marked graph. Generally, a process marked graph is a marked graph containing disjoint cycles called processes, each node of the graph belonging to one process, and whose marking contains a single token on an edge in any process. For example, nodes 201a and 201b and edges 205 and 206 represent the producer process, and nodes 202a and 202b and edges 207 and 208 represent the consumer process.

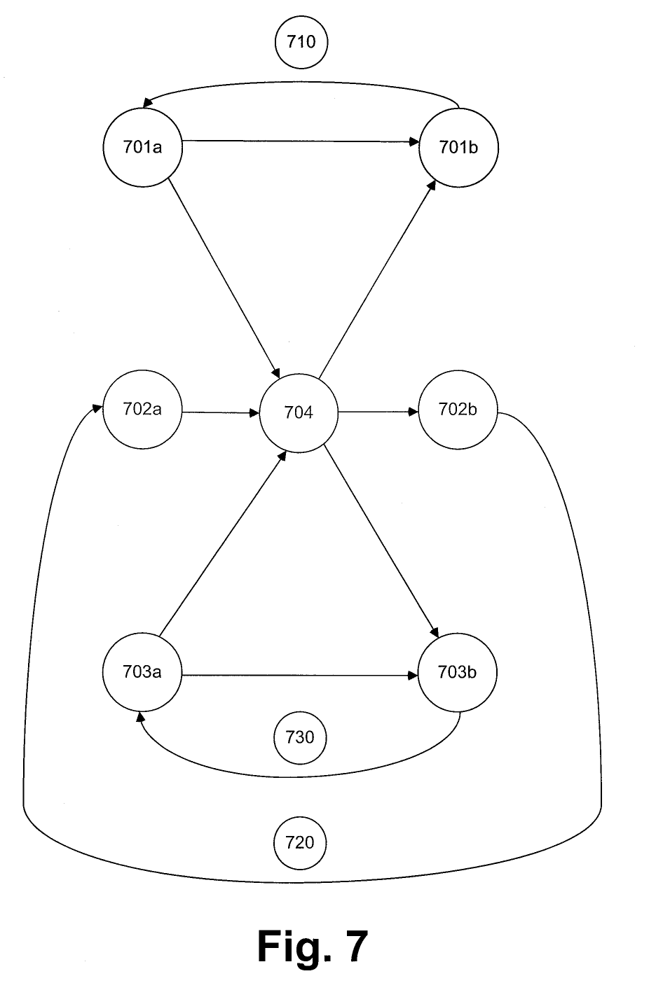

FIG. 6 is a process marked graph representing barrier synchronization. In barrier synchronization, a set of processes repeatedly execute a computation such that, for each i≧1, every process must complete its i^{th} execution before any process begins its (i+1)^{st} execution. FIG. 6 shows barrier synchronization for three processes where the processes are the three cycles comprising the nodes 601a and 601b and the edges joining them; 602a and 602b and the edges joining them; and 603a and 603b and the edges joining them.

The edges [symbol] 601b, 601a [symbol] 602b, 602a [symbol] and [symbol] 603b, 603a [symbol] may be described as computation edges. A token on any of these edges represents the process performing its associated computation. In this example, the there are no buffers represented in the graph. The 6 edges not belonging to one of the processes described above, create barrier synchronization by ensuring that none of the nodes 601b, 602b, and 603b are fire-able for the (i+1)^{st} time until all three nodes 601a, 602a and 603a have fired i times.

FIG. 7 illustrates another way to represent barrier synchronization for three processes as is shown in FIG. 6. The marked graph of FIG. 7 creates barrier synchronization because none of the nodes 701b, 702b, and 703b are fire-able for the (i+1)^{st} time before 704 has fired i times, which may occur after nodes 701a, 702a, and 703a have fired i times, for example. As is discussed below, applying the algorithm for implementing a process marked graph to the graphs of FIGS. 6 and 7 may yield different barrier synchronization algorithms.

A marked graph may be represented as a pair [symbol] Γ, μ₀ [symbol] where Γ is a directed graph and μ₀ is the initial marking that assigns to every edge e of Γ a number μ₀[e] corresponding to the number of tokens on e. With respect to FIG. 2, Γ may comprise the nodes 201 and 202, as well as edges 204 and 203. The initial marking, μ₀, may comprise the tokens 201, 220, and 230, including their current location on the graph. Any suitable data structures known in the art may be used to represent Γ and μ₀, for example.

As described above, a particular node n in the graph is fire-able for a particular μ iff μ[e]>0 for every in-edge e of n. The value in Edges(n) may be defined as the set of all in-edges of a particular node n. Thus, looking at FIG. 2, inEdges(201) desirably includes edge 203. Fire(n, μ) may be defined as a function that returns the particular μ that results after firing a node n for a particular μ. Thus, firing node 201 with the μ shown in FIG. 2 would result in the μ corresponding to the graph shown in FIG. 3, for example.

One way to implement a marked graph is with message passing. For example, a token on an edge [symbol] m, n [symbol] from process π₁ to a different process π₂ may be implemented by a message that is sent by π₁ to π₂ when the token is put on the edge. The message may be removed by π₂ from its message buffer when the token is removed. Any system, method, or technique known in the art for message passing may be used. However, current multi-processors do not provide message-passing primitives. Therefore, process marked graphs may be implemented using read and write operations to shared memory as described below.

A process marked graph may be represented as a triple [symbol] Γ,μ₀, Π [symbol] where
[symbol] Γ, μ₀ [symbol] is a marked graph.
Π is a set of disjoint cycles of Γ called processes such that each node of Γ is in exactly one process π of Π. For example, as shown in FIG. 5, nodes 202a and 202b and the edges joining them represent a process.
For any process in Γ there is initially only one token on any of the edges within that process.

In an execution of a process marked graph, each process desirably contains a single token that cycles through its edges. The nodes of the a process π are desirably fired in a cyclical order, starting with a first node π[1], then proceeding to a second node π[2], and so forth.

A particular instance of the algorithm associated with a process π desirably maintains an internal state identifying which edge of the cycle contains the token. Accordingly, in order to determine if a particular node is fire-able, only the incoming edges that belong to different process are desirably examined. These incoming edges that belong to a different process are known as synchronizing in-edges. For example, the edge 203 in FIG. 5 is an example of a synchronizing in-edge of the process comprising the nodes 201a and 201b. The function SInEdges(n) desirably returns that set of synchronizing edges for any particular node n belonging to any process π.

The following is an algorithm for implementing an arbitrary live process-marked graph. The example algorithm is implemented using the +cal algorithm language, however those skilled in the art will appreciate that the algorithm can be implemented using any language known in the art. The algorithm and the notation used is explained in the text that follows.

```
--algorithm Algorithm 1
variables μ = μ₀; cnt = [c ∈ Ctrs [symbol] 0]
process Proc ∈ Π
    variables i = 1 ; ToCheck
    begin lab : while TRUE do
        ToCheck := SInEdges(self [i ]) ;
      loop : while ToCheck ≠ { } do
        with e ∈ ToCheck do
            if CntTest(cnt, e) then
            ToCheck := ToCheck \ {e} end if
        end with
      end while
    fire : cnt[CtrOf [self [i]]] := cnt[CtrOf [self [i]]] ⊕ Incr[self [i]] ;
    Execute computation for the process edge from node self [i];
    i := (i %Len(self)) + 1 ;
    end while
end process
end algorithm
```

The variables statements declare variables and initialize their values. The variable cnt is initialized to an array indexed by the set Ctrs so that cnt[c]=0 for every c in Cntrs. The process statement describes the code for a set of processes, with one process for every element of the set Π of processes. Within the process statement, the current process is called self. A process in the set Π is a cycle of nodes, so self[i] is the i^{th} node of process self.

The statement
with e ε ToCheck do . . .
   sets e to an arbitrarily chosen element of the set ToCheck and then executes the do clause.

As described above, certain process edges (i.e., edges belonging to the cycle that is a process), called computation edges, represent a computation of the process. If the process edge that begins at node self[i] is a computation edge, then the statement:

Execute computation for the process edge from node self[i]

Executes the computation represented by the edge. If that edge is not a computation edge, then this statement does nothing (i.e., is a no-op).

The algorithm utilizes a set Ctr of counters and a constant Ctr-Valued array CtrOf indexed by the nodes in the marked graph. The set Ctr and the array CtrOf may be chosen in a way that satisfies the following condition:

Condition 1: For any nodes m and n, if CtrOf[m]=CtrOf[n] then m and n belong to the same process. Accordingly, nodes within the same process may share the same counter.

The counter CtrOf[n] is used to control the firing of node n. More precisely, for any synchronizing edge [symbol] m, n [symbol] , the values of the counters CtrOf[m] and CtrOf[n] are used to determine if there is a token on that edge. The value of the variable i determines on which process edge of the process there is a token, specifically, the token is located on the process in-edge of the node self[i]. As explained above, node n can desirably be fired only when there is at least one token on each of its input edges.

The algorithm assumes a positive integer N having certain properties described below. The operator ⊕ is addition modulo N, thus a ⊕ b=(a+b)% N. Similarly, the operator ⊖ is subtraction modulo N, thus a ⊖ b=(a−b)% N.

Before describing the algorithm further, some additional notation is defined:
┌k┐^{Q} is defined as the smallest multiple of Q that is greater than or equal to k, for any natural number k. Stated another way, ┌k┐^{Q}=Q*┌k/Q┐, where ┌r┐ is the smallest integer greater than or equal to r.
If μ is a marking of the graph Γ, and m and n are nodes of Γ, then δ_{μ}(m, n) is the distance from m to n in Γ if every edge of Γ is considered to have length μ[e];
Sum(x ε S, exp) is the sum of the expression exp for all elements x in the set S. For example, Sum(x ε {1, 2, 3}, x²)=1²+2²+3².
The algorithm utilizes a constant array Incr of natural numbers indexed by nodes of Γ satisfying the following conditions:
Condition 2: For every node m having a synchronizing out-edge, Incr[n]>0.
Condition 3: The expression Sum(n ε Nds(c), Incr[n]) has the same value for all nodes c, where Nds(c) is the set of nodes n such that Ctr[n] c. This value is referred to as Q.
Condition 4: (a) N is divisible by Q, and (b) N>Q*δ_{μ0}(n, m)+Q*μ₀ [symbol] m, n [symbol] , for every synchronizing edge [symbol] m, n [symbol] .
CntTest(cnt, e) is defined to equal the following Boolean-valued expression, when e is the edge [symbol] m, n

[symbol]

┌bcnt(n)┐^{Q}⊖┌bcnt(m)┐^{Q}≠(Q*μ₀ [symbol] m, n [symbol] ), where
bcnt(p) equals cnt[CtrOf[p]] ⊖cnt₀ (p) for any node p, where
For any process π and any i between 1 and the length of the cycle π, cnt₀(π[i]) is defined to equal Sum(j ε Pr(i), Incr[π[j]]), where Pr(i) is the set of all j with 1≦j<i, such that CtrOf(π[j])=CrtOf(π[i]). This implies that cnt₀(n) is the amount by which node n's counter is CtrOf[n] is incremented before n is fired for the first time.

As shown, each iteration of the outer while loop of Algorithm 1 implements the firing of node self[i]. When executing the algorithm for each process in the graph, this loop can be unrolled into a sequence of separate copies of the body for each value of i. If self[i] has no input synchronizing edges, then the inner while statement performs 0 iterations and can be eliminated, along with the preceding assignment to ToCheck, for the process associated with that value of i. If Incr[self[i]]=0, then the statement labeled fire does nothing and can be similarly eliminated.

As described in the background section, the shown algorithms are desirably implemented in a multi-processor, or multi-core environment. Currently, accesses to shared memory (i.e., memory out side of a particular processor's cache) are typically many times slower than an access to local memory. Accordingly, Algorithm 1 may be further optimized by eliminating unnecessary reads from one process to another. Specifically, unnecessary reads may be eliminated using process counters where there can be more than one token on a particular synchronizing edge, for example. As is discussed below, this is the case for the producer/consumer type graphs, but not for the barrier synchronization graphs which have one token on synchronizing in-edges.

When a particular process computes CntTest(cnt, e), it is desirably determining whether the number of tokens on a particular edge e is greater than 0. Instead, the process could just determine μ[e], the actual number of tokens on edge e. If μ[e]>1, then the process knows that the tokens needed to fire node self[i] the next μ[e]−1 times are already on edge e. Therefore, the next μ[e]−1 tests for a token on edge e may be eliminated or skipped. This reduces the number of reads of the counter for e's source node.

This optimization is used in the Algorithm 2, illustrated below:

```
--algorithm Algorithm 2
variables μ = μ₀; cnt = [c ∈ Ctrs [symbol] 0]
    toks = [e ∈ ProcInEdges(self) [symbol] μ₀[e] − 1];
process Proc ∈ Π
    variables i = 1 ; ToCheck
    begin lab : while TRUE do
        ToCheck := SInEdges(self [i]) ;
      loop : while ToCheck ≠ { } do
        with e ∈ ToCheck do
            if toks[e] ≦ 0 then toks[e] := CntMu(cnt, e) −1
                else toks[e] := toks[e] − 1 end if ;
            if toks[e]≠ −1 then ToCheck := ToCheck \ {e} end if
        end with
      end while
    fire : cnt[CtrOf [self [i]]] := cnt[CtrOf [self [i]]] ⊕ Incr[self [i]] ;
    Execute computation for the process edge from node self [i];
    i := (i %Len(self)) + 1 ;
    end while
end process
end algorithm
```

As described above, this optimization eliminates memory accesses for edges e of the process marked graph that can contain more than one token.

### Application of Algorithm to Process Marked Graphs

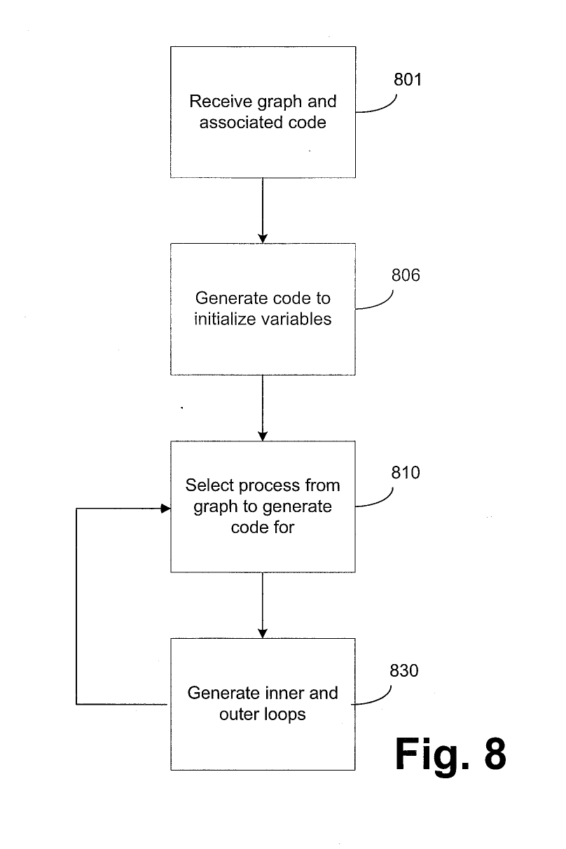

FIG. 8 is an illustration of a method for generating code suitable for execution on a multi-threaded architecture from a process marked graph. The method applies Algorithm 1 or 2 to a received process marked graph and code associated with the processes contained in the graph. The result is code that can be executed by multiple threads or separate processors, while maintaining the dataflow described in the process marked graph.

At 801, a process marked graph is selected or received to be processed. The process marked graph desirably comprises a plurality of nodes and edges, and a marking that associates each edge in the graph with some number of tokens. Any suitable data structure or combination of structures known in the art may be used to represent the process marked graph.

The graph may further comprise processes, with each node belonging to one of the processes within the graph. In addition, each process may have code associated with the execution of that process. For example, as described above, FIG. 5 represents the producer and consumer system. The producer process desirably has associated code that specifies how the producer produces data that is applied to the buffers represented by one or more of the markings on the graph. Similarly, the consumer process desirably has associated code that specifies how the data in one or more of the buffers is consumed. The code may be in any suitable programming language known in the art. The code associated with each process may be specified in separate files corresponding to each of the processes in the graph, for example.

At 806, a statement initializing one or more variables to be used by each of the processes may be generated. These variables desirably include a set of counters associated with each of the nodes comprising the processes. These counters may be implemented suing any suitable data structure known in the art.

At 810, a process in the set of processes comprising the graph may be selected to be converted into executable code. Ultimately, every process in the graph is desirably converted. However, the conversion of a single process to an executable is discussed herein.

At 830, an outer and inner loop may be generated for the process. The outer loop contains the inner loop, the code associated with the execution of the particular process, and a statement that updates the marking of the graph after firing the current node of the process. Any system, method, or technique for creating a loop may be generated.

The inner loop desirably continuously checks the set of synchronizing in-edges into a current node. The number of tokens on a particular synchronizing in-edge may be checked by reference to the counter associated with the node that the edge originates from. Using CntTest(cnt, e), for example. This function desirably returns true if the number of tokens is greater than zero, and false otherwise. However, calculating this value may require a read to one of the global counters, possibly on another processor, for example. It may be desirable to instead calculate the actual value of tokens on the particular synchronizing in-edge, and then store that value in a variable associated with that particular edge. Later executions of the process for the same node may then skip checking the number of tokens of the particular edge so long as the stored value is greater than zero. In addition, the stored value is desirably decremented by one each time the associated node is fired.

The inner loop desirably removes edges from the set of synchronizing in-edges once it is determined that there is at least one token on them. Once the set of synchronizing in-edges is empty (i.e., all of the edges have tokens), the node is fire-able, and the loop may exit.

After the end of the inner loop, a fire statement is desirably inserted. As described above, the fire statement desirably takes as an argument the current node, and the current marking of the graph, and updates the marking to reflect that the current node has been fired. Updating the marking of the graph may be accomplished by updating the counters associated with the corresponding nodes. For example, as shown in Algorithm 1, the statement

cnt[CtrOf[self[i]]]:=cnt[CtrOf [self [i]]]⊕Incr[self [i]],

updates the marking to reflect that the current node, i.e., node self[i], has been fired.

The fire statement may be followed by the particular code associated with execution of the process. This code may have been provided by the creator of the process marked graph in a file, for example. The execution of this code is conditioned on the process out-edge of the current node being a computation edge. If the edge is a computation edge, then the code may be executed. Otherwise, the program desirably performs a no-op, for example.

In addition, the counter identifying the current node in the process is desirably incremented by 1 modulo the total number of nodes in the process. This ensures that the execution returns to the first node after the last node in the process is fired. After generating the code for the current process, the embodiment may return to 810 to generate the code for any remaining processes in the set of processes. Else, the embodiment may exit and the resulting code may be compiled for execution. After the pieces of code have been compiled, they may be executed on separate threads on a single process, or on separate processors.

Depending on the particulars of the processes in the process marked graph, the application of Algorithm 1 to the graph may be further optimized accordingly. For example, the algorithm 1 may be applied to the process marked graph of FIG. 5. As described above, this graph represents producer/consumer synchronization. In the resulting algorithms Prod and Cons represent the producer and consumer processes, except with an arbitrary number B of tokens on edge [symbol] 202b, 201b [symbol] instead of 3. As described previously, each token may represent a buffer. A token on edge [symbol] 201b, 201a [symbol] represents a produce operations and a token on edge [symbol] 202a, 202b [symbol] represents a consume operation. The producer and consumer processes may each have an associated single counter that is desirably incremented by 1 when 201a or 202b is fired, for example.

Because firing 201b or 202b does not increment a counter, it may be eliminated in the iterations of the outer while loop when i=1. Because 201a and 202a as shown in the Figure have no synchronizing in-edges, the inner while loop can be eliminated in the iteration for i=2. The iterations for i=1 and i=2 are desirably combined into one loop body that contains the statement loop for i=1 followed by the statement fire for i=2. Because the execution of the produce or consume operation begins with the firing of 201b or 202a and ends with the firing of 201a or 202b, the corresponding code is desirably placed between the code for the two iterations, for example.

Instead of a single array cnt of variables, p and c are used for the for the producer's and consumer's counters respectively. The two CntTest conditions can be simplified to p ⊖ c≠B and p ⊖ c≠0, respectively. Writing the producer and consumer as separate process statements results in the algorithm ProdCons:

```
--algorithm ProdCons
variables p=0; c=0
process Prod = “p”
    begin lab : while TRUE do
        loop : while p ⊖ c = B do skip end while
            Produce;
        fire : p:=p ⊕ 1;
    end while
end process
process Cons = “c”
    begin lab : while TRUE do
        loop : while p ⊖ c = 0 do skip end while
            Consume;
        fire : c:=c ⊕ 1;
    end while
end process
end algorithm
```

As shown, the process Prod continuously checks the value of p ⊖ c to see if it is B, the total number of tokens. If it is B, then all of the buffers are full, and there is no need to produce. Thus, the process skips to the end of the loop without firing. However, once a buffer becomes available (i.e., p ⊖ c≠B), the process does not skip, and the code corresponding to Produce is executed, and p is increased by 1.

Similarly, the process Cons continuously checks the value of p ⊖ c to see if it is zero. If it is zero, then there is nothing in the buffers, and therefore, nothing to consume. Accordingly, the process skips to the end and continues to check the value of p ⊖ C. Once the value of p ⊖ c does not equal zero, then the code associated with the consume operation is desirably executed, and c is desirably fired by incrementing it by 1.

Algorithm 1 may also be similarly applied to barrier synchronization, as shown by the process marked graph of FIG. 6. One counter may be used per process, incremented by 1 by the process's first node and left unchanged by its second node. Therefore, Q=1. Condition 4(b) requires N>2. For example, for edge [symbol] 601a, 602b [symbol] δμ₀ (602b, 601a)+μ₀ [symbol] 601a, 602b [symbol] equals 2+0.

The process comprising nodes 601a and 601b may be referred to as process X. The process comprising nodes 602a and 602b may be known as process Y. The process comprising nodes 603a and 603b may be known as process Z. The name of particular process may be used as its counter name. Therefore, process X uses counter X, and so forth. Because cnt₀(601a)=0 and cnt₀(602b)=1, formula CntTest(cnt, [symbol] 601a, 602b [symbol] becomes cnt[Y]−cnt[X]≠1.

In general, to apply Algorithm 1 to the generalized process marked graph, the set of counters is desirably the same as the set of processes Π in the particular graph. Each process π desirably increments cnt[π] by 1 when firing node π[1] and leaves it unchanged when firing node π[2]. Because π[1] has no synchronizing in-edges and firing π[2] does not increment counter π, combining the while loops desirably yields a loop body with a statement fire for i=1 followed by a statement loop for i=2.

The statement PerformComputation desirably contains the particular code for the computation corresponding to edge [symbol] π[2], π[1 [symbol] for each process (i.e., the particular code that we are trying to synchronize) and precedes the fire statement. For each process π, cnt₀(π[1])=0 and cnt₀(π[2])=1, so CntTest(cnt, [symbol] π[1], self[2] [symbol] equals cnt[self]−cnt[π]≠1, for any process π≠self. The resulting algorithm, Barrier1, is illustrated below:

```
--algorithm Barrier1
variable cnt = [c ∈ Π [symbol] 0]
process Proc ∈ Π
    variable ToCheck
    begin lab : while TRUE do
            Perform Computation;
        fire : cnt[self]:= cnt[self ] ⊕ 1 ;
            ToCheck := Π \ {self};
        loop : while ToCheck ≠ { } do
            with π ∈ ToCheck do
                if cnt[self] ⊖ cnt[π] ≠1 then
                    ToCheck := ToCheck \ { π } end if
            end with
        end while
    end while
end process
end algorithm
```

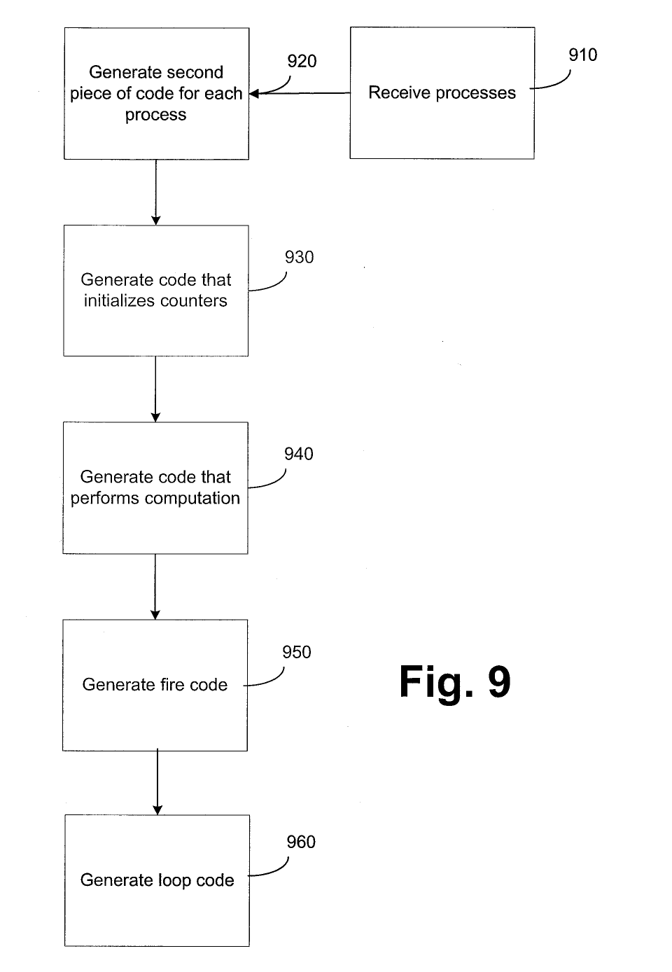

FIG. 9 is a block diagram illustrating a method for the barrier synchronization of processes by applying the algorithm Barrier1. At 901, a group of processes or applications are received. Each process includes executable code. The executable code associated with each process may be different, or each process may have the same code.

At 920, a second piece of executable code is created for each of the processes. This piece of executable code creates barrier synchronization of the received processes. The remaining steps in this Figure describe the generation of the second piece of code for each of the processes.

At 930, code may be inserted into the second piece of code that initializes a counter for the particular process. The counter is desirably initialized to zero.

At 940, code that triggers the execution of the executable code associated with the particular process is desirably inserted. This executable code is desirably the same code received at 901. For example, this step corresponds to the Perform Computation step shown in Barrier1

At 950, code may be inserted that increments the counter assigned the particular process. This code corresponds to the fire statement in Barrier1.

At 960, code may be inserted that waits for each of the other counters associated with the other processes to reach a threshold. For example, the threshold may be each counter equal to 1. This portion of code corresponds to the loop statement in barrier 1, for example. After the second pieces of code have been generated, they may be executed on separate threads on a single processor, or on separate processors to achieve barrier synchronization.

Similarly, a barrier synchronization algorithm can be derived from algorithm 1 applied to the generalization of the process marked graph illustrated in FIG. 7, for example. In that generalization, a single distinguished process π₀ represents the middle process (i.e, the process comprising nodes 702a, 704, and 702b). Each process is again assigned a single counter. The algorithm for every process other than π₀ is desirably the same as in algorithm Barrier1, except that node π[2] has only a single synchronizing in-edge for whose token it must wait. Because nodes π₀[1] and π₀[3] have neither synchronizing in-edges nor out-edges, the iterations of process π₀'s while loop for i=1 and i=3 do nothing. For any process π≠π₀,

CntTest(cnt [symbol] π[1],π[2 [symbol] equals cnt[π₀]−cnt[π]≠0 which is equivalent to cnt[π₀]≠cnt[π], since cnt[π₀] and cnt[π] are in the set {0, 1 . . . (N−1)}. The resulting algorithm, Barrier2, is illustrated below:

```
--algorithm Barrier2
variable cnt = [c ∈ Π [symbol] 0]
process Proc ∈ Π \ { π₀}
    begin lab : while TRUE do
            Perform Computation;
        fire : cnt[self]:= cnt[self ] ⊕ 1 ;
        loop : while cnt[self] ⊖ cnt[π₀] =1 do skip
        end while
    end while
end process
process Proc0 = π₀
variable ToCheck
    begin lab : while TRUE do
            Perform Computation
            ToCheck := Π \ { π₀};
        loop : while ToCheck ≠ { } do
            with π ∈ ToCheck do
                if cnt[π₀] = cnt[π] then
                    ToCheck := ToCheck \ {π} end if
            end with
        end while
        fire : cnt[π₀]:= cnt[π₀] ⊕ 1
    end while
end process
end algorithm
```

Algorithm Barrier2 may be more efficient than algorithm Barrier1 because Barrier2 performs fewer memory operations. Approximately 2*P rather than P², for P processes, for example. However, the synchronization algorithm Barrier2 uses a longer information-flow path—length 2 rather than length 1, which may result in a longer synchronization delay.

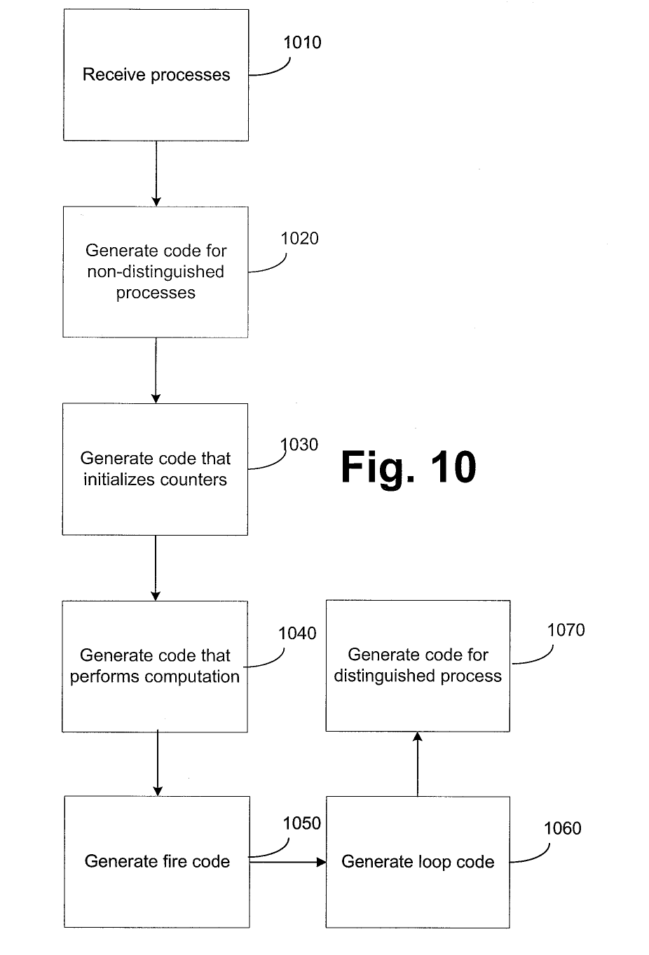

FIG. 10 is a block diagram illustrating a method for the barrier synchronization of processes by applying the algorithm Barrier2. At 1010, a group of processes or applications are received. Each process includes executable code. The executable code associated with each process may be different, or each process may have the same code. In addition, a process is selected as the distinguished process. The distinguish process is only unique in that it will have different code generated for the barrier synchronization than the other processes.

At 1020, a second piece of executable code is created for each of the processes other than the distinguished process. This piece of executable code creates barrier synchronization of the received processes other than the distinguished process. The following four steps in this Figure describe the generation of the second piece of code for each of the processes other than the distinguished process.

At 1030, code may be inserted into the second piece of code that initializes a counter for the particular process. The counter is desirably initialized to zero.

At 1040, code that triggers the execution of the executable code associated with the particular process is desirably inserted. This executable code is desirably the same code received at 1010. For example, this step corresponds to the Perform Computation step shown in Barrier2

At 1050, code may be inserted that increments the counter assigned the particular process. This code corresponds to the fire statement in Barrier2.

At 1060, code may be inserted that waits for a counter associated with the distinguished process to reach a threshold. This portion of code corresponds to the loop statement in Barrier2, for example.

At 1070, the second piece of code is generated for the distinguished process. The generation of the code for the disguised process is similar to the generation of the code for the other processes, except the loop statement for the distinguished process waits until the counter associated with the distinguished process is equal to the counters associated with all of the other processes, and the distinguished process does not increment its counter, i.e., the fire statement until after the loop statement is completed. After the second pieces of code have been generated, they may be executed on separate threads on a single processor, or on separate processors to achieve barrier synchronization.

Barrier synchronization algorithms Barrier1, and Barrier2, all require that at least one process reads the counters of every other process. This may be impractical for a large set of processes. A number of “composite” barrier synchronization algorithms may therefore be employed, each involving a small number of processes. Each composite barrier synchronization algorithm can be described by a process marked graph. For example, if a separate counter is assigned to every node with synchronizing out-edges and Algorithm 1 is applied, a version of the composite algorithm using Barrier1 as the component algorithm is created. However, a single counter per process may also be used. Applying Algorithm 1 provides a simpler version of the composite algorithm in which the component synchronizations use the same variables.

Algorithms 1 and 2 may be implemented using caching memories. In a caching memory system, a process may acquire either a read/write copy of a memory location or a read-only copy in its associated processor cache. Acquiring a read/write copy invalidates any copies in other processes' caches. This is to prevent processes from reading old or outdated values from their caches because the process with the read/write copy may have altered the value stored in the memory location, for example.

A read of a process's counter by that process may be done on a counter stored locally at the processor associated with the process, or can be performed on a local copy of the counter. During the execution of Algorithm 2, accesses of shared variables are performed during the write of node self[i]'s counter in statement fire, and the read of a particular node m's counter by the evaluation of CntMu(cnt [symbol] m, self[i [symbol] . When a particular process reads node m's counter, the value that the process reads desirably remains in its local cache until the counter is written again.

If it assumed that each counter is incremented when firing only one node, then Q=1. A write of a particular node m's counter then announces the placing of another token on edge [symbol] m, self[i [symbol] Therefore, when the previous value of the counter is invalidated in the associated process's cache, the next value the process reads allows it to remove the associated edge from ToCheck. For Algorithm 2, this implies that there is one invalidation of the particular process's copy of m's counter for every time the process waits on that counter. Because transferring a new value to a process's cache is how processes communicate, no implementation of marked graph synchronization can use fewer cache invalidations. Therefore, the optimized version of Algorithm 2 is optimal with respect to caching when each counter is incremented by firing only one node.

If a particular node m's counter is incremented by nodes other than m, then there are writes to that counter that do not put a token on edge [symbol] m, self[i [symbol] A process waiting for the token on that edge may read values of the counter written when firing those other nodes, leading to possible additional cache invalidations. Therefore, cache utilization is guaranteed to be optimal only when Q=1.

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

1. A method for synchronizing dataflow between multiple processes, comprising:
receiving a process marked graph, the graph comprising processes, each process comprising at least one node, wherein the nodes are connected by edges and the process marked graph describes a dataflow between the processes on the graph;
receiving code corresponding to one or more of the processes in the process marked graph; and
generating code for each of the processes in the process marked graph, wherein the code for each process includes the corresponding received code and implements the dataflow described by the process marked graph, and the generated code for each process includes:
instructions that indicate a current node of the process;
instructions that determine if there is a token on each of the synchronizing in-edges into the current node in the process, and wait until there is a token on each of the synchronizing in-edges into the current node in the process;
instructions that execute the received code corresponding to the current process if the current node contains a process edge; and
instructions that fire the current node and advance the current node of the process to a next node in the process.

2. The method of claim 1, wherein each node in each process is assigned a counter, and the instructions that determine if there is a token on each of the synchronizing in-edges into the current node in the process further comprise instructions that reference the counter associated with the current node to determine if there is a token on each of the synchronizing in-edges.

3. The method of claim 2, wherein the instructions that advance the current node of the process to a next node in the process further comprise instructions to update the counters of nodes to reflect the firing of the current node.

4. The method of claim 1, wherein the code for each process is executed as a separate thread on a processor.

5. The method of claim 1, wherein the code for each process is executed on a separate processor.

6. The method of claim 5, wherein the tokens correspond to buffers shared by one or more threads or processors.

7. A method for the barrier synchronization of multiple processes, comprising:
receiving a first piece of code for each of the processes; and
generating a second piece of code for each of the processes, wherein the generated second piece of code for each process includes:
a counter assigned to the process;
instructions that trigger the execution of the first piece of code associated with the process;
instructions that increment the counter assigned to the process after executing the first piece of code; and
instructions that determine if counters associated with each of the other processes have reached a threshold, and wait until the counters associated with each of the other processes have reached the threshold.

8. The method of claim 7, wherein the threshold is reached when the counters associated with the other processes are each greater than zero.

9. The method of claim 7, further comprising instructions that jump to the instructions of the second piece of code that trigger the execution of the first piece of code when the counters associated with each of the other processes have reached the threshold.

10. The method of claim 7, further comprising compiling the generated second pieces of code.

11. The method of claim 7, further comprising executing each of the generated second pieces of code as separate threads in a processor.

12. The method of claim 7, further comprising executing each of the generated second pieces of code on separate processors.

13. A method for the barrier synchronization of multiple processes, comprising:
receiving a first piece of code for each of the processes, wherein the processes include a distinguished process; and
generating a second piece of code for each of the processes other than the distinguished process, wherein the generated second piece of code includes:
a counter assigned to the process;
instructions that trigger the execution of the first piece of code associated with the process;
instructions that increment the counter assigned to the process after executing the first piece of code; and
instructions that determine if a counter associated with the distinguished process has reached a threshold, and wait until the counter associated with the distinguished process has reached the threshold.

14. The method of claim 13, further comprising instructions that jump to the instructions of the second piece of code that trigger the execution of the first piece of code when the counters associated with each of the other processes have reached the threshold.

15. The method of claim 13, further comprising generating a second piece of code for the distinguished process, wherein the generated second piece of code includes:
the counter assigned to the distinguished process;
instructions that trigger the execution of the first piece of code associated with the distinguished process;
instructions that determine if the counters associated with the other processes have reached a second threshold, and wait until the counters associated with the other process have reached the second threshold; and
instructions that increment the counter assigned to the distinguished process.

16. The method of claim 15, further comprising executing each of the generated second pieces of code as separate threads in a processor.

17. The method of claim 15, further comprising, further comprising executing each of the generated second pieces of code on separate processors.

18. The method of claim 15, wherein the second threshold is reached when the counters associated with the other processes are equal to the counter associated with the distinguished process.

19. The method of claim 13, further comprising executing each of the generated second pieces of code as separate threads in a processor.

20. The method of claim 13, further comprising executing each of the generated second pieces of code on separate processors.
